(19) United States
(12) Patent Application Publication
(10) Pub. No.: US 2021/0322141 A1
(43) Pub. Date: Oct. 21, 2021

(54) Toothbrush head and an electric toothbrush

(71) Applicant: Shenzhen Huohu Technology Co., Ltd., Baoan Dist. (CN)

(72) Inventors: Huajie HE, Maoming (CN); Mingfeng HE, Maoming (CN); Shuai Yuan, Shenzhen (CN)

(21) Appl. No.: 17/359,555

(22) Filed: Jun. 26, 2021

(30) Foreign Application Priority Data
Apr. 16, 2021 (CN) 202110416045.7

(51) Int. Cl. A61C 17/22

(52) U.S. Cl. CPC A61C 17/222

(57) ABSTRACT

The present invention discloses a toothbrush head and an electric toothbrush, wherein the toothbrush head is connected to the drive shaft of the toothbrush handle, and comprises a toothbrush head and a clamping piece. The toothbrush head comprises a brush end and a connecting end that are opposite to each other. The clamping piece is installed on the connecting end, and provided with an elastic arm and a clamping slot for clamping the drive shaft. One end of the elastic arm close to the brush end is a free end, and some part of the sidewall of the clamping slot is formed by the elastic arm. The elastic arm is further provided with a butting boss. The butting boss protrudes from the elastic arm into the clamping slot, and can be elastically butted with the drive shaft. The toothbrush head provided by the prevent invention can solve the technical problem that the toothbrush head on some existing electric toothbrushes is difficult to detach from the toothbrush handle.

### TECHNICAL FIELD

The present invention relates to the technical field of electric toothbrushes, in particular to a toothbrush head and an electric toothbrush.

### BACKGROUND ART

An electric toothbrush generally comprises a toothbrush head and a toothbrush handle. The toothbrush handle is provided with a drive shaft and a motor that drives the drive shaft to vibrate. The drive shaft is connected to the toothbrush head to drive the toothbrush head to vibrate. In some existing electric toothbrushes, the toothbrush head is fixed to the toothbrush handle in order to ensure the stability of the connection between the toothbrush head and the toothbrush handle. As a result, when either the toothbrush head or the toothbrush handle breaks down, it is difficult to remove for replacement or repair.

The aforesaid content is only used to assist in understanding the technical proposal of the present invention, and not recognized as prior art.

### SUMMARY OF THE INVENTION

The main purpose of the present invention is to provide a toothbrush head with the aim of solving the technical problem that the toothbrush head on some existing electric toothbrushes is difficult to detach from the toothbrush handle.

In order to achieve the aforesaid purpose, the toothbrush head provided by the present invention is used for connecting to the drive shaft of the toothbrush handle, and comprises a toothbrush head and a clamping piece. The toothbrush head comprises a brush end and a connecting end that are opposite to each other. The clamping piece is installed on the connecting end, and provided with an elastic arm and a clamping slot for clamping the drive shaft. An end of the elastic arm that is close to the brush end is a free end, and some part of the sidewall of the clamping slot is formed by the elastic arm. The elastic arm is further provided with a butting boss. The butting boss protrudes from the elastic arm into the clamping slot, and can be elastically butted with the drive shaft.

In one embodiment, the clamping slot comprises a front part close to the brush end, a rear part far away from the brush end, and middle part located between the front part and the rear part. The butting boss is disposed opposite the middle part.

In one embodiment, the free end of the elastic arm is disposed opposite the middle part, and the butting boss is located at the free end of the elastic arm.

In one embodiment, the butting boss comprises a second butting surface for a butting connection with the first butting surface, and the second butting surface gradually tilts toward the inside of the clamping slot in a direction close to the brush end.

In one embodiment, the concave surface of the elastic arm facing the clamping slot is provided with a first spacing groove for the embedding of the drive shaft, and the butting boss is arranged in the first spacing groove.

In one embodiment, there is a mounting groove at the connecting end of the toothbrush head, and the clamping piece is installed in the mounting groove; the mounting groove is provided with a second spacing groove that extends along the axial direction of the toothbrush head, a first spacing ribbed strip is provided outside of the clamping piece, and the first spacing ribbed strip is clamped in the second spacing groove along the axial direction of the toothbrush head; and/or, the mounting groove is provided with a second spacing ribbed strip that extends along the axial direction of the toothbrush head, a third spacing groove is provided outside of the clamping piece, and the third spacing groove is clamped to the second spacing ribbed strip along the axial direction of the toothbrush head.

In one embodiment, the clamping piece further comprises a base and a fixed arm, the fixed arm and the elastic arm are both connected to the base. The fixed arm and the elastic arm are arranged opposite each other, forming a clamping slot; the first spacing ribbed strip is arranged on surface of the fixed arm that faces away from the elastic arm.

In one embodiment, the inner surface of the mounting groove is further provided with a clamping slot, the outer surface of the base is further provided with a clamping cam that matches with the clamping slot for clamping, and the clamping piece is detachably clamped to the mounting groove via the clamping cam and the clamping slot.

The present invention also provides an electric toothbrush. The electric toothbrush comprises a toothbrush head and a toothbrush handle. The toothbrush handle is provided with a drive shaft, and the toothbrush head is connected to the drive shaft. The toothbrush head comprises:

A toothbrush head, which comprises a brush end and a connecting end that are opposite to each other; and

a clamping piece, which is installed on the connecting end and provided with an elastic arm and a clamping slot for clamping the drive shaft. One end of the elastic arm closer to the brush end is a free end, and some part of the sidewall of the clamping slot is formed by the elastic arm.

The elastic arm is further provided with a butting boss. The butting boss protrudes from the elastic arm into the clamping slot, and can be elastically butted with the drive shaft.

In one embodiment, the drive shaft comprises a first butting surface for a butting connection with the butting boss, and in the radial direction of the toothbrush head, the width of the butting boss is not less than the width of the first butting surface.

The toothbrush head provided by the present invention is provided with an elastic arm on the clamping piece, the elastic arm forms some part of the sidewall of the clamping slot, and the butting boss on the elastic arm protrudes from the elastic arm into the clamping slot. Understandably, as the size of a clamping slot generally fits the drive shaft on the toothbrush handle, the drive shaft squeezes the elastic arm, thus causing elastic deformation of the elastic arm when it is inserted into the clamping slot. When it undergoes elastic deformation, the elastic arm applies an opposite acting force to the drive shaft through the butting boss, thereby clamping the drive shaft stably to the clamping slot to achieve a stable connection between the toothbrush head and the toothbrush handle to prevent the toothbrush head from loosing or coining off the toothbrush handle when the electric toothbrush is in use. In addition, as the drive shaft is elastically clamped in the clamping slot, it is only necessary to put forth strength to pull out the drive shaft when there is a need to remove the toothbrush head from the toothbrush handle. It is very convenient and efficient to do so.

Also, one end of the elastic arm is connected to the clamping piece, and the other end of the elastic arm is a free end, so that it is quite easy to push open and squeeze the elastic arm when the drive shaft is inserted, and that the deformation of the elastic arm is just right, thereby applying a sufficient acting force to the drive shaft to ensure that the drive shaft is stably clamped in the clamping slot.

In addition, compared with some existing electric toothbrushes, the toothbrush head provided by the present invention does not need a metallic elastic element (e.g. metal shrapnel) to clamp the drive shaft on the toothbrush handle, omitting the processing and assembly processes of the metallic elastic element. As a result, the production and processing of the electric toothbrush are more environmentally friendly. Moreover, the processing course of the electric toothbrush is greatly simplified, reducing the production cost.

### DESCRIPTION OF THE DRAWINGS

In order to explain the embodiments of the present invention or the technical protocols in the prior art more clearly, the embodiments or the drawings required for the description of the prior art will be briefly introduced below. Notably, the drawings in the following description are only some embodiments of the present invention. For those skilled in the art, other drawings can be obtained according to the structure shown in these drawings without the need to do creative work.

FIG. 1 shows a partial structural diagram of the electric toothbrush provided by the present invention in one embodiment;

FIG. 2 shows a structural diagram of the toothbrush head in the toothbrush head provided by the present invention in one embodiment;

FIG. 3 shows a partial structural cross-sectional view of the electric toothbrush provided by the present invention in one embodiment;

FIG. 4 shows a partial structural diagram of the toothbrush head provided on the electric toothbrush in FIG. 3;

FIG. 5 shows a structural schematic diagram of the toothbrush head provided by the present invention in another embodiment;

FIG. 6 shows a structural schematic diagram of the electric toothbrush provided by the present invention in another embodiment;

FIG. 7 shows a partial structural diagram of the toothbrush head provided on the electric toothbrush in FIG. 6;

FIG. 8 shows a structural schematic diagram of the toothbrush head provided by the present invention in a further embodiment;

FIG. 9 shows a structural schematic diagram of the drive shaft and the motor in the electric toothbrush provided by the present invention in one embodiment;

### DESCRIPTION OF MARK NUMBERS IN THE DRAWINGS

| Mark | |
|---|---|
| Number | Name |
| 10 | Toothbrush Head |
| 20 | Toothbrush Head |
| 21 | Brush End |
| 22 | Connecting End |
| 23 | Mounting Groove |
| 231 | Second Spacing Groove |
| 232 | Second Spacing Ribbed Strip |
| 233 | Third Spacing Ribbed Strip |
| 234 | Clamping Slot |
| 30 | Clamping Piece |
| 31 | Elastic Ann |
| 311 | Butting Boss |
| 312 | Free End |
| 313 | Second Butting Surface |
| 314 | First Spacing Groove |
| 32 | Clamping Slot |
| 321 | Front Part |
| 322 | Middle Part |
| 323 | Rear Part |
| 33 | First Spacing Ribbed Strip |
| 34 | Third Spacing Groove |
| 35 | Base |
| 36 | Fixed Arm |
| 37 | Clamping Cam |
| 38 | Buffer Groove |
| 40 | Drive shaft |
| 41 | First Butting Surface |
| 42 | Clamping Shaft Segment |
| 50 | Motor |

The achievement of the purpose of the present invention, and the functional characteristics and advantages of the present invention will be further described by reference to the drawings.

### Embodiments

It should be noted that if one embodiment of the present invention comprises a direction indication (e.g. “up, down, left, right, front, rear . . . ), the direction indication is only used to interpret the relative positional relationship among various parts and their movement under a certain attitude (see the Drawings). If a change takes place in the certain attitude, the direction indication changes accordingly.

Further, there are “first” and “second” in one embodiment of the present invention, the words “first” and “second” are only used for description, and cannot be understood as the number of the technical features that indicate or imply its relative importance. Thus, the presence of “first” or “second” can explicitly or implicitly indicate that at least this feature is contained. In the present application, “and/or” has three parallel meanings. Taking “A and/or B” as an example, it means A only, B only, and both A and B. Further, the technical protocols for various embodiments can be combined with one another, but the premise is that those skilled in the art can do so. If the technical protocols combined together are contradictory or it is impossible to combine certain technical protocols together, the combination of the technical protocols should be considered to be non-existent and beyond the scope of the present invention.

The present invention provides an electric toothbrush. As shown in FIG. 1, the electric toothbrush comprises a toothbrush head 10 and a toothbrush handle (not shown in the drawing). The toothbrush handle is provided with a drive shaft 40 and a motor 50 that drives the drive shaft 40 to vibrate. The drive shaft 40 is connected to the toothbrush head 10 to drive the toothbrush head 10 to vibrate.

But in some existing electric toothbrushes, the toothbrush head 10 is fixed to the toothbrush handle in order to ensure the stability of the connection between the toothbrush head 10 and the toothbrush handle. As a result, when either the toothbrush head 10 or the toothbrush handle breaks down, it is difficult to remove for replacement or repair. Therefore, the present invention further provides a toothbrush head 10 to solve the above technical problem.

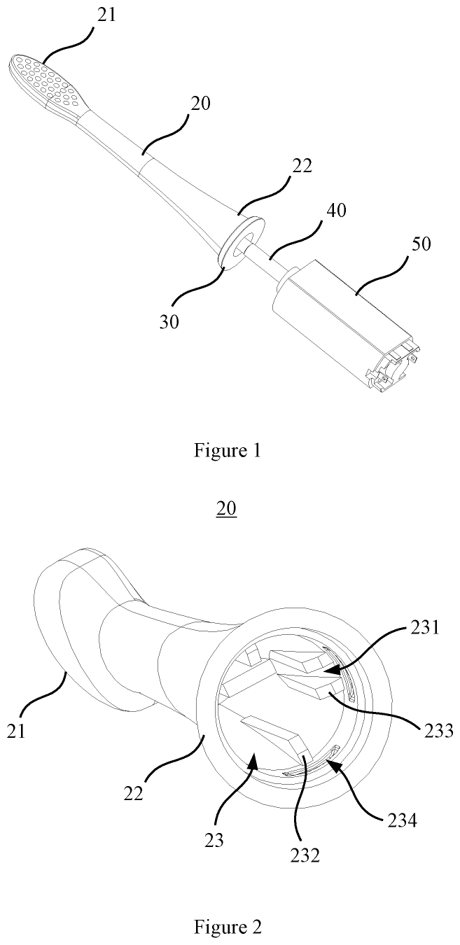

In one embodiment of the present invention, as shown in FIG. 2˜8, the toothbrush head 10 is used for connecting to the drive shaft 40 on the toothbrush handle and comprises a toothbrush head 20 and a clamping piece 30. As shown in FIG. 2, the toothbrush head 20 comprises a brush end 21 and a connecting end 22 that are opposite to each other. The brush end 21 is an end with a brush. A mounting groove 23 is provided on the connecting end 22, and the mounting groove 23 can be formed in the hollow interior of the toothbrush head 20.

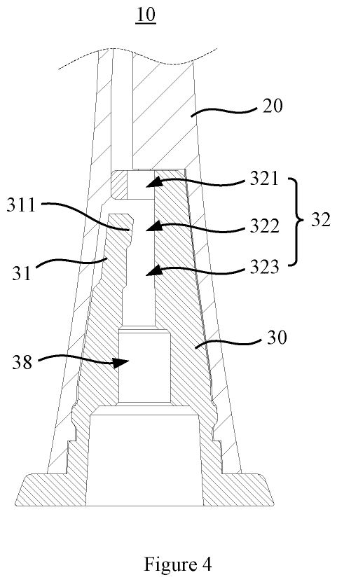

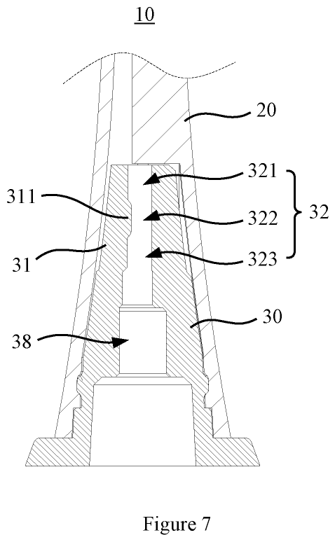

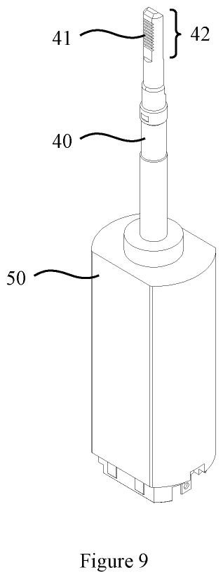

The clamping piece 30 is mounted on the connecting end 22, in particular, in the mounting groove 23. The mounting method can be bolt fastening, clamping or bonding, etc. as the case may be. As shown in FIG. 4 or FIG. 7, the clamping piece 30 also comprises an elastic arm 31 and a clamping slot 32 for clamping the drive shaft 40. It should be noted that, in order to enable the drive shaft 40 to stably drive the toothbrush head 20, as shown in FIG. 9, the drive shaft 40 is generally provided with a clamping shaft segment 42 that is located on its end and comprises a butting surface. The entire drive shaft 40 comes into surface contact with the clamping slot 32 via the clamping shaft segment 42. Therefore, the clamping slot 32 mentioned in the present protocol refers to a slot segment that comes into actual surface contact with the clamping shaft segment 42 on the drive shaft 40. For example, in one embodiment, as shown in FIG. 4 or FIG. 7, the clamping piece 30 is internally provided with a clamping slot 32 and a buffer groove 38 that is connected to the clamping slot 32. The buffer groove 38 is used for the drive shaft 40 to pass through to be clamped to the clamping slot 32.

In the present embodiment, the elastic arm 31 is close to one end of the brush end 21 as a free end 312, and some part of the sidewall of the clamping slot 32 is formed by the elastic arm 31. Specifically, to implement above structure, the entire clamping piece 30 can be made of an elastic material, and after the clamping slot 32 is formed, some part of the side of the clamping slot 32 can be bent outward by non-cut-off processing technology. The outwardly bendable part of the side can be used an elastic arm 31.

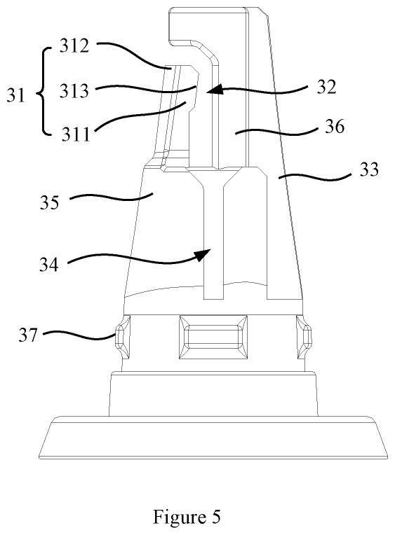

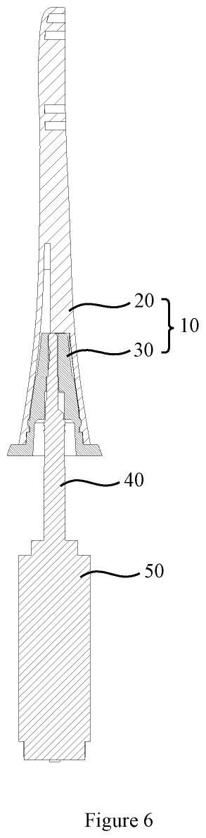

Of course, as shown in FIG. 5, the clamping piece 30 can also comprise a base 35 and a fixed arm 36. The elastic arm 31 and the fixed arm 36 are both connected to the base 35. The fixed arm 36 and the elastic arm 31 are arranged opposite each other, forming a clamping slot 32;

Understandably, one end of the elastic arm 31 is connected to the clamping piece 30. When the other end is a free end 312, the drive shaft 40 can push open and squeeze the elastic arm 31 more easily, and the deformation of the elastic arm 31 is just right, thereby applying a sufficient acting force to the drive shaft 40 to ensure that the drive shaft is stably clamped in the clamping slot 32.

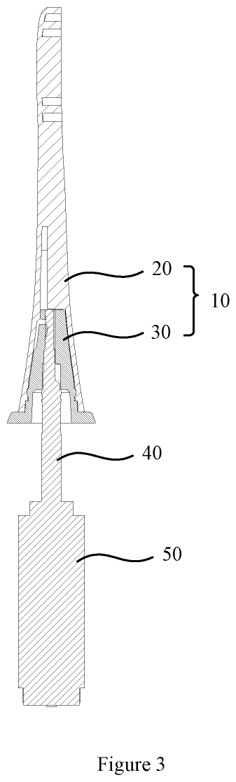

In the present embodiment, as shown in FIGS. 3 and 4, the elastic arm 31 is further provided with a butting boss 311; the butting boss 311 protrudes from the elastic arm 31 into the clamping slot 32, and can be elastically butted with the drive shaft 40. Understandably, as the size of a clamping slot 32 generally fits the drive shaft 40 on the toothbrush handle, the drive shaft 40 squeezes the elastic arm 31, thus causing elastic deformation of the elastic arm 31 when it is inserted into the clamping slot 32. When it undergoes elastic deformation, the elastic arm 31 applies an opposite acting force to the drive shaft 40 through the butting boss 311, thereby clamping the drive shaft 40 stably to the clamping slot 32 to achieve a stable connection between the toothbrush head 20 and the toothbrush handle. And as the drive shaft 40 is elastically clamped in the clamping slot 32, it is only necessary to put forth strength to pull out the drive shaft 40 when there is a need to remove the toothbrush head 20 from the toothbrush handle. It is very convenient and efficient to do so.

In one embodiment, in order to ensure that the drive shaft 40 is clamped firmly to the elastic arm 31, the drive shaft 40 comprises a first butting surface 41 for a butting connection with the butting boss 311, and in the radial direction of the toothbrush head 20, the width of the butting boss 311 is not less than the width of the first butting surface 41. In other words, the width of the butting boss 311 can be equal to the width of the first butting surface 41, or greater than that the width of the first butting surface 41. It should be noted that the butting boss 311 comprises a second butting surface 313 for a butting connection with the first butting surface 41, and the width of the butting boss 311 in the radial direction of the toothbrush head 20 is the same as the width of the second butting surface 313.

Understandably, when the width of the butting boss 311 is set to be large, the width of the elastic arm 31 provided with the butting boss 311 should also be set to be large. Compared with the elastic arm with a smaller width, the elastic arm 31 with a large width can apply a greater clamping force to the drive shaft 40 after deformation, thus ensuring the table clamping of the drive shaft 40.

In one embodiment, as shown in FIG. 4 or FIG. 7, the clamping slot 32 comprises a front part 321 close to the brush end 21, a rear part 323 far away from the brush end 21, and middle part 322 located between the front part 321 and the rear part 323. The butting boss 311 is disposed opposite the middle part 322. Specifically, the drive shaft 40 is generally provided with a clamping shaft segment 42 at its end that comprises a first butting surface 41. The entire drive shaft 40 is in surface contact with the clamping slot 32 via the clamping shaft segment 42, and the drives the toothbrush head 10 to vibrate. The areas at the two ends of the clamping shaft segment 42 correspond to the front part 321 and the rear part 323 of the clamping slot 32, while the central position of the clamping shaft segment 42 corresponds to the middle part 322 of the clamping slot 32. Therefore, when the butting boss 311 is located opposite the middle part 322 of the clamping slot 32, it can be butted with the central position of the clamping shaft segment 42, so that the drive shaft 40 can drive the toothbrush head 10 to vibrate better and more stably.

In one embodiment, as shown in FIG. 4, the free end 312 of the elastic arm 31 is disposed opposite the middle part 322. The butting boss 311 is located at the free end 312 of the elastic arm 31. In the present embodiment, on the premise that the butting boss 311 can be butted with the central position of the clamping shaft segment 42, the butting boss 311 is located at the free end 312 of the elastic arm 31, so that it is quite easy to push open and squeeze the elastic arm 31 when the drive shaft 40 is inserted, and that the elastic arm 31 applies a greater force to the drive shaft 40, ensuring that the drive shaft 40 is stably clamped in the clamping slot 32.

In one embodiment, as shown in FIG. 4, the drive shaft 40 comprises a first butting surface 41 for a butting connection with the butting boss 311, the butting boss 311 comprises a second butting surface 313 for a butting connection with the first butting surface 41, and the second butting 313 surface gradually tilts toward the inside of the clamping slot 32 in a direction close to the brush end 21. Understandably, the elastic arm 31 deflects at a certain angle when it suffers from squeezing deformation owing to the drive shaft 40. The second butting surface is arranged obliquely so that after the elastic arm 31 deflects at a certain angle, it can just be parallel to the first butting surface on the drive shaft 40, thereby creating a sufficient area of surface contact between the butting boss 311 and the drive shaft 40 to ensure that the drive shaft 40 is clamped stably in the clamping slot 32.

Besides, as shown in FIGS. 3 and 4, when the free end 312 of the elastic arm 31 is disposed opposite the middle part 322 of the clamping slot 32, the front part 321 of the clamping slot 32 can be provided with a ring structure with a spacing hole in order to prevent the front end of the drive shaft 40 corresponding to the front part 321 of the clamping slot 32 from tilting, so that the front end of the drive shaft 40 is located in the spacing hole in the process of insertion.

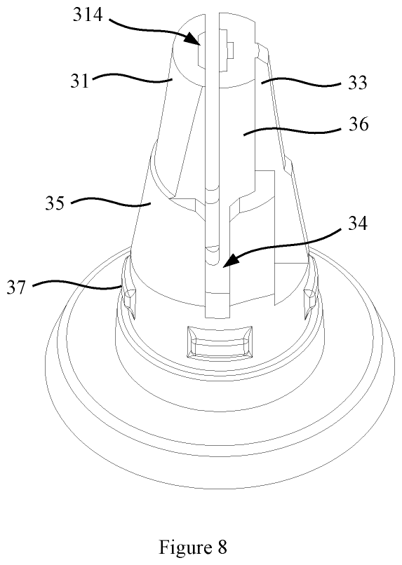

In one embodiment, as shown in FIGS. 6 and 8, the concave surface of the elastic arm 31 facing the clamping slot 32 is provided with a first spacing groove 314 for the embedding of the drive shaft 40, and the butting boss 311 is arranged in the first spacing groove 314. Specifically, when the drive shaft 40 is inserted into the clamping slot 32, the side with the first butting surface 41 is embedded in the first spacing groove 314. The first spacing groove 314 can prevent the drive shaft 40 from tilting with respect to the butting boss 311, ensuring that the driving shaft 40 and the butting boss 311 are accurately butted with each other, and there is a sufficient area of contact between them.

In one embodiment, as shown in FIGS. 2, 5 and 8, there is a mounting groove 23 at the connecting end 22 of the toothbrush head 20, and the clamping piece 30 is installed in the mounting groove 23; the mounting groove 23 is provided with a second spacing groove 231 that extends along the axial direction of the toothbrush head 20, a first spacing ribbed strip 33 is provided outside of the clamping piece 30, and the first spacing ribbed strip 33 is clamped into the second spacing groove 231 along the axial direction of the toothbrush head 20; understandably, the arrangement of first spacing ribbed strip 33 and the second spacing groove 231 helps to accelerate the positioning of the clamping piece 30 when it is installed on the toothbrush head 20, and prevent the clamping piece 30 from rotating after installation, thereby ensuring a stable connection between the toothbrush head 10 on the toothbrush handle.

Besides, in the present embodiment, the second spacing groove 231 is formed by two third spacing ribbed strips 233 arranged in the mounting groove 23 and the two third spacing ribbed strips 233 are integrally-formed with the toothbrush head 20 in order to simplify the structure and the processing course.

In a further embodiment, as shown in FIGS. 2, 5 and 8, the mounting groove 23 is provided with a second spacing ribbed strip 232 that extends along the axial direction of the toothbrush head 20, a third spacing groove 34 is provided outside of the clamping piece 30, and the third spacing groove 34 is clamped to the second spacing ribbed strip 232 along the axial direction of the toothbrush head 20. This also helps to accelerate the positioning of the clamping piece 30 when it is installed on the toothbrush head 20, and prevent the clamping piece 30 from rotating after installation.

In one embodiment, as shown in FIG. 5 or 8, the clamping piece 30 further comprises a base 35 and a fixed arm 36; the fixed arm 36 and the elastic arm 31 are both connected to the base 35. The fixed arm 36 and the elastic arm 31 are arranged opposite each other, forming a clamping slot 32; the first spacing ribbed strip 33 is arranged on surface of the fixed arm 36 that faces away from the elastic arm 31. In this way, the first spacing ribbed strip 33 can function as a reinforcing rib to strengthen the fixed arm 36 on the basis of fixation and preventing rotation. Further, when the drive shaft 40 is inserted into the clamping slot 32, the fixed arm 36 is basically not deformed under the action of the first spacing ribbed strip 33. Instead, the elastic arm 31 is deformed, allowing the drive shaft 40 to pass through it, thereby ensuring that the elastic arm 31 applies a sufficient elastic force to the drive shaft 40, so that the drive shaft 40 is clamped stably.

In one embodiment, the inner surface of the mounting groove 23 is further provided with a clamping groove 234, the outer surface of the base 35 is further provided with a clamping cam 37 that matches with the clamping groove 234 for clamping, and the clamping piece 30 is detachably clamped to the mounting groove 23 via the clamping cam 37 and the clamping groove 234. Understandably, the clamping cam 37 and the clamping groove 234 cooperate with each other, greatly facilitating the assembly and disassembly of the clamping piece 30 on the toothbrush head 20.

Of course, a clamping cam 37 can also be provided inside of the mounting groove 23 on the toothbrush head 20, and a clamping groove 234 can be provided outside of the clamping slot 30 as the case may be. In order to ensure the stability of clamping, a plurality of clamping cams 37 and clamping grooves 234 can be arranged at intervals along the circumferential direction of the toothbrush head 20.

The electric toothbrush provided by the present invention comprises a toothbrush handle and a toothbrush head 10. A drive shaft 40 is installed on the toothbrush handle. The drive shaft 40 is used for connecting to the toothbrush head 10 to drive the toothbrush head 10 to vibrate. Please refer to the aforesaid embodiments for the specific structure of the toothbrush head 10. Considering that all the technical protocols in all the aforesaid embodiments are adopted for the electric toothbrush, it has at least all the beneficial effects brought by the technical protocols in the aforesaid embodiments, and the details will not be described one by one here.

The above are just preferred embodiments of the present invention, and do not limit the scope of the present invention. Any equivalent structure transformation made in accordance with the specification of the present invention and the content of the drawings under the inventive concept of the present invention or directly or indirectly applied to other related technical fields is included in the scope of patent protection of the present invention.

1. A toothbrush head, used for connecting to the drive shaft of the toothbrush handle, is characterized in that the toothbrush head comprises:
a toothbrush head, which comprises a brush end and a connecting end that are opposite to each other;
a clamping piece, which is installed on the connecting end and provided with an elastic arm and a clamping slot for clamping the drive shaft. An end of the elastic arm that is close to the brush end is a free end, and some part of the sidewall of the clamping slot is formed by the elastic arm;
the elastic arm is further provided with a butting boss; and
the butting boss protrudes from the elastic arm into the clamping slot, and can be elastically butted with the drive shaft.

2. The toothbrush head, according to claim 1, is characterized in that the clamping slot comprises a front part close to the brush end, a rear part far away from the brush end, and middle part located between the front part and the rear part; and the butting boss is disposed opposite the middle part.

3. The toothbrush head, according to claim 2, is characterized in that the free end of the elastic arm is disposed opposite the middle part, and the butting boss is located at the free end of the elastic arm.

4. The toothbrush head, according to claim 3, is characterized in that the drive shaft comprises a first butting surface for a butting connection with the butting boss, the butting boss comprises a second butting surface for a butting connection with the first butting surface, and the second butting surface gradually tilts toward the inside of the clamping slot in a direction close to the brush end.

5. The toothbrush head, according to claim 2, is characterized in that the concave surface of the elastic arm facing the clamping slot is provided with a first spacing groove for the embedding of the drive shaft, and the butting boss is arranged in the first spacing groove.

6. The toothbrush head, according to claim 1, is characterized in that there is a mounting groove at the connecting end of the toothbrush head, and the clamping piece is installed in the mounting groove;
The mounting groove is provided with a second spacing groove that extends along the axial direction of the toothbrush head, a first spacing ribbed strip is provided outside of the clamping piece, and the first spacing ribbed strip is clamped in the second spacing groove along the axial direction of the toothbrush head;
And/or, the mounting groove is provided with a second spacing ribbed strip that extends along the axial direction of the toothbrush head, a third spacing groove is provided outside of the clamping piece, and the third spacing groove is clamped to the second spacing ribbed strip along the axial direction of the toothbrush head.

7. The toothbrush head, according to claim 6, is characterized in that the clamping piece further comprises a base and a fixed arm. The fixed arm and the elastic arm are both connected to the base. The fixed arm and the elastic arm are arranged opposite each other, forming a clamping slot;
The first spacing ribbed strip is arranged on surface of the fixed arm that faces away from the elastic arm.

8. The toothbrush head, according to claim 7, is characterized in that the inner surface of the mounting groove is further provided with a clamping groove, the outer surface of the base is further provided with a clamping cam that matches with the clamping slot for clamping, and the clamping piece is detachably clamped to the mounting groove via the clamping cam and the clamping groove.

9. An electric toothbrush, which is characterized in that it comprises:
the toothbrush head as claimed in claim 1; and
a toothbrush handle, which is provided with a drive shaft, and the toothbrush head is connected to the drive shaft.

10. The electric toothbrush, according to claim 9, is characterized in that the drive shaft comprises a first butting surface for a butting connection with the butting boss, and in the radial direction of the toothbrush head, the width of the butting boss is not less than the width of the first butting surface.
